(19) United States
(12) Patent Application Publication
(10) Pub. No.: US 2026/0296215 A1
(43) Pub. Date: Oct. 1, 2026

(54) METHOD FOR OPERATING AN ELECTRIC VEHICLE WITH A DEVICE FOR GENERATING A VIRTUAL SHIFTING SENSATION AS WELL AS ELECTRIC VEHICLE

(71) Applicant: Dr. Ing. h.c. F. Porsche Aktiengesellschaft, Stuttgart (DE)

(72) Inventors: Markus LINDERMEIER, Vaihingen an der Enz (DE); Benno WIESNER, Fellbach (DE); Jan-Peter HOFFMEISTER, Leonberg (DE)

(21) Appl. No.: 19/629,029

(22) Filed: Mar. 26, 2026

(30) Foreign Application Priority Data
Apr. 1, 2025 (DE) 10 2025 112 729.8

(51) Int. Cl. B60L 15/20

(52) U.S. Cl. CPC B60L 15/20; B60L 2250/28

(57) ABSTRACT

A method is for operating an electric vehicle. The electric vehicle includes a drive unit including at least one electric motor and a device for generating a virtual shifting sensation. The method includes preventing, depending on a detected cornering of the electric vehicle, virtual downshifts and/or virtual upshifts of the device for generating the virtual shift sensation.

### CROSS REFERENCE TO RELATED APPLICATIONS

This application claims benefit to German Patent Application No. DE 10 2025 112 729.8, filed on Apr 1, 2025, which is hereby incorporated by reference herein.

### FIELD

The invention relates to a method for operating an electric vehicle with a device for generating a virtual shifting sensation. Furthermore, the invention relates to an electric vehicle with a device for generating a virtual shifting sensation.

### BACKGROUND

Electric vehicles are also referred to as battery electric vehicles. The drive unit of an electric vehicle has at least one electric motor, but no combustion engine. In a motor vehicle whose drive unit has a combustion engine, a multi-speed manual gearbox is connected between the internal combustion engine and an output of the motor vehicle, which for reasons of efficiency is increasingly designed as an automatic gearbox. In an automatic gearbox, gear changes are performed automatically based on a driver-side actuation of the accelerator pedal and/or brake pedal. Furthermore, automatic gearboxes are known in which gear changes are also performed manually based on a driver-side actuation of a sequential shift element, such as a shift paddle.

In an electric vehicle, there is no multi-speed manual gearbox between the electric motor and the output; at most, there is a reduction gearbox with typically a single, fixed transmission ratio or a maximum of two transmission ratios. Gear changes, as known from motor vehicles with combustion engines and multi-speed manual gearboxes, are not performed in electric vehicles. Therefore, drivers who switch from a combustion engine vehicle to an electric vehicle typically find the driving experience in an electric vehicle to be less emotional.

As explained above, the drive unit of a motor vehicle designed as an electric vehicle has at least one electric motor, but no combustion engine. The electric vehicle has a traction battery in which electrical energy is stored for operating at least one electric motor. In a range extender electric vehicle, the same may be available via an internal combustion engine for charging the traction battery, but the internal combustion engine is not part of the drive unit in a range extender electric vehicle, since even in a range extender electric vehicle, only the at least one electric motor at the drive output of the electric vehicle provides drive power, but not the combustion engine. The same applies to a fuel cell electric vehicle, in which the fuel cell is used to charge the traction battery.

US 2021/0 309 113 A1 discloses an electric vehicle with a device for generating a virtual shifting sensation.

DE 10 2022 211 435 A1 discloses another electric vehicle with a device for generating a virtual shifting sensation.

### SUMMARY

In an embodiment, the present disclosure provides a method for operating an electric vehicle. The electric vehicle includes a drive unit including at least one electric motor, and a device for generating a virtual shifting sensation. The method includes preventing, depending on a detected cornering of the electric vehicle, virtual downshifts and/or virtual upshifts of the device for generating the virtual shift sensation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an electric vehicle according to an embodiment of the present disclosure;

FIG. 2 illustrates a block diagram of assemblies of the electric vehicle according to an embodiment of the present disclosure; and

FIG. 3 illustrates a block diagram for further clarifying according to an embodiment of the present disclosure.

### DETAILED DESCRIPTION

The present inventors have found that there is a need to increase the driving experience in an electric vehicle while maintaining driving stability.

Embodiments of the present disclosure provide a method for operating an electric vehicle and an electric vehicle.

According to an embodiment of the present disclosure, depending on detected cornering of the electric vehicle, virtual downshifts and/or virtual upshifts of the device for generating the virtual shift sensation are prevented.

According to an embodiment of the present disclosure, the driving experience in an electric vehicle can be enhanced while maintaining driving stability. When cornering, in particular embodiments for dynamic cornering, the device for generating the virtual shifting sensation may prevent virtual downshifts and/or upshifts.

In a preferred embodiment, the set-up for generating the virtual shifting sensation may be operated in an automatic operating mode or in a manual operating mode, wherein the device for generating the virtual shifting sensation generates a virtual automatic shifting sensation in the automatic operating mode and a virtual manual shifting sensation in the manual operating mode. In a preferred embodiment, if the device for generating the virtual shifting sensation can be operated in the automatic operating mode and in the manual operating mode, then virtual downshifts and/or virtual upshifts will only be prevented during cornering when the automatic operating mode of the device for generating the virtual shifting sensation is active.

In manual operating mode, virtual downshifts and/or virtual upshifts are performed automatically by the device for generating the virtual shifting sensation depending on a driver-side actuation of the accelerator pedal and/or depending on a driver-side actuation of the brake pedal. In manual operating mode, virtual downshifts and/or virtual upshifts are performed depending on a driver-side actuation of a shift element, and in particular embodiments a sequential shift element such as a shift paddle. Accordingly, in manual operating mode, virtual downshifts and/or virtual upshifts are allowed even if cornering is detected. Only in automatic operating mode does the device for generating the virtual shifting sensation prevent virtual downshifts and/or virtual upshifts when cornering is detected. This is particularly preferred in order to increase the driving experience of electric vehicles.

In a preferred embodiment, cornering is detected depending on a longitudinal acceleration of the electric vehicle, wherein cornering of the electric vehicle is detected if the current longitudinal acceleration is greater than a limit value preferably depending on a current driving speed and/or of a current driving mode and/or of a current virtual gear of the device for generating a virtual shifting sensation. This is particularly preferred for detecting cornering and for the dependent prevention of virtual shifting.

In a preferred embodiment, virtual downshifts and/or virtual upshifts of the device for generating a virtual shifting sensation are only prevented for detected cornering when a forward driving stage is active as the driving stage. This is preferable in order to then, when the device for generating the virtual shifting sensation based on detected cornering prevents virtual downshifts and/or virtual upshifts, to exit the respective suppression of the respective virtual shift and to enhance the driving experience while maintaining driving stability.

In a preferred embodiment, if virtual downshifts of the device for generating a virtual shifting sensation are prevented for detected cornering, then the prevention of virtual downshifts is then ended when a virtual engine speed in the current virtual gear is below a virtual idling speed. In a preferred embodiment, when virtual upshifts of the device for generating a virtual shifting sensation are prevented during cornering, the prevention of virtual upshifts is ended when a virtual engine speed in the current virtual gear exceeds a virtual speed limit value. This is also preferable in order to then, when the device for generating the virtual shifting sensation based on detected cornering prevents virtual downshifts and/or virtual upshifts, to exit the respective suppression of the respective virtual shift and to enhance the driving experience while maintaining driving stability.

In a preferred embodiment, when virtual backshifts and/or virtual upshifts are prevented based on detected cornering, the prevention of the virtual downshifts and/or the virtual upshifts is ended when the forward driving stage is no longer active and/or when a timer has elapsed. This is also preferable in order to then, when virtual downshifts and/or virtual upshifts are prevented for detected cornering, to exit the suppression of the respective virtual shift and to enhance the driving experience while maintaining driving stability.

Example embodiments of the invention will be explained in more detail with reference to the drawing, without being restricted thereto.

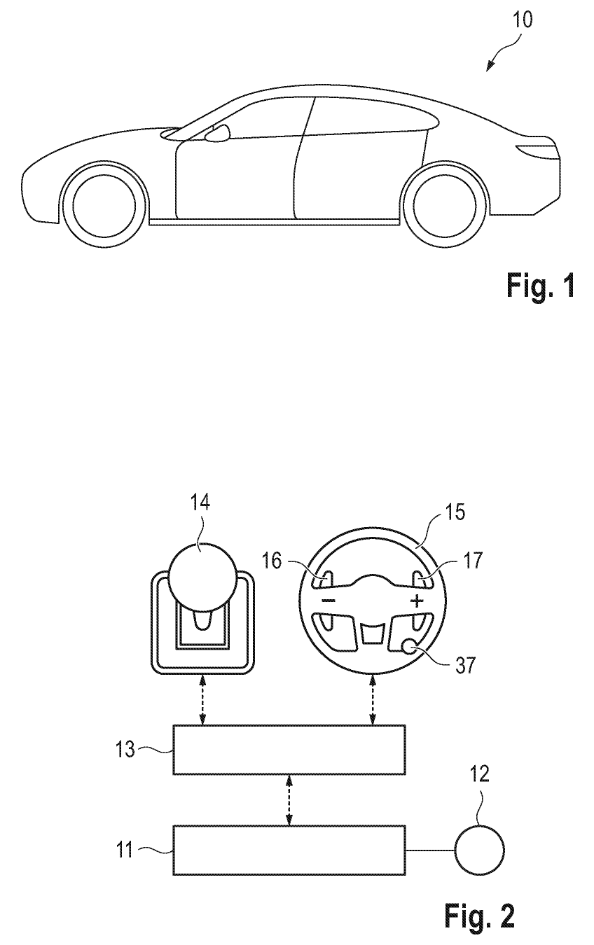

FIG. 1 shows a motor vehicle designed as an electric vehicle 10. In an electric vehicle 10, a drive unit thereof has at least one electric motor 11, but no combustion engine. It is possible that the drive unit of the electric vehicle 10 has a single electric motor 11, which then drives an axle of the electric vehicle 10. The drive unit of the electric vehicle 10 may also comprise several electric motors 11. For example, with two driven axles of the electric vehicle 10, each of the driven axles may be assigned an individual electric motor 11, wherein the electric vehicle 10 then has two electric motors 11.

Each driven wheel of the electric vehicle 10 can also be assigned an individual electric motor 11, wherein the number of electric motors 11 of the drive unit of the electric vehicle 10 corresponds to the number of driven wheels of the electric vehicle 10. The number of electric motors 11 in the drive unit of the electric vehicle 10 is purely illustrative.

FIG. 2 shows highly schematized assemblies of an electric vehicle 10, namely an electric motor 11, which provides drive power to a drive output 12 of the electric vehicle 10. In an electric vehicle 10, unlike combustion engine-powered motor vehicles, there is no multi-speed manual gearbox between the electric motor 11 and the drive output 12, but at most a reduction gearbox with a single, fixed transmission ratio or two transmission ratios. Accordingly, in electric vehicles 10, gear changes are not performed as is known from internal combustion engine motor vehicles depending on the driver’s actuation of the accelerator pedal and/or depending on the driver’s actuation of a brake pedal of the electric vehicle 10 in a multi-speed manual gearbox. This limits the driving experience of an electric vehicle 10.

In order to enhance the driving experience of an electric vehicle 10, an electric vehicle 10 according to an embodiment of the present disclosure comprises a device 13 for generating a virtual shifting sensation.

The device 13 for generating a virtual shifting sensation can simulate a virtual gearbox with virtual shifts by means of the device 13 for generating the virtual shifting sensation controlling the at least one electric motor 11 of the electric vehicle 10 in such a way that the at least one electric motor 11 provides a torque profile at the output 12 that corresponds to a torque profile that would be formed when gear changes are performed in combustion engine-powered motor vehicles with a multi-speed manual gearbox.

When the device 13 for generating the virtual shifting sensation is deactivated, the electric vehicle 10 is operated like a conventional electric vehicle without performing virtual shifting.

If, on the other hand, the device 13 for generating the virtual shifting sensation is activated, it generates a virtual shifting sensation for a driver. In so doing, the device 13 for generating the virtual shifting sensation can, in a preferred embodiment, generate either a virtual automatic switching sensation in a first, automatic operating mode, or a virtual manual shifting sensation in a second, manual operating mode.

In the first automatic operating mode, the device 13 simulates the presence of an automatic, multi-speed manual gearbox such that the device 13 for generating a virtual shifting sensation depending on the driver's actuation of an accelerator pedal and/or depending on the driver’s actuation of a brake pedal performs virtual automatic shifting, and by controlling the electric machine 11 at the drive output 12, it provides a torque curve that would be formed at the output 12 if an automatic multi-speed manual gearbox were present.

The torque curve to be provided at the drive output 12 in the first, automatic operating mode can, in particular embodiments, be determined by the device 13 for generating the virtual shifting sensation based on the actuation of the accelerator pedal and/or based on the actuation of the brake pedal in a map-based manner, and in particular embodiments also based on a virtual current gear and virtual target gear of the respective virtual shift to be performed.

On the other hand, when the second, manual operating mode of the device 13 for generating the virtual shifting sensation is activated, the device 13 generates a virtual manual shifting sensation, in particular embodiments depending on the driver’s actuation of sequential shift elements 16, 17 installed on a steering wheel 15 of the electric vehicle, which can be embodied as shift paddles in the example embodiment shown. If the second, manual operating mode of the device 13 for generating the virtual shifting sensation is active, the device 13 for generating the virtual shifting sensation depending on the driver’s actuation of the sequential shift element 16, 17 controls the electric motor 11 in such a way that it performs the same virtual sequential shifts and provides a torque curve at the drive output 12 that would be formed if a multi-speed manual gearbox operated in sequential shift mode or operating mode were present in the electric vehicle 10.

The torque curve to be provided at the drive output 12 in the second, manual operating mode can be determined in particular by the device 13 for generating the virtual shifting sensation depending on the actuation of the respective sequential shift element 16, 17 in a mapped-based manner.

The device 13 for generating the virtual shifting sensation simulates the presence of a multi-speed manual gearbox depending on the operating mode of the same.

When the device 13 for generating the virtual shifting sensation is activated, it can, in a preferred embodiment, be operated in two operating modes, namely, as described above, in the first automatic operating mode or in the second manual operating mode. When the device 13 for generating the virtual shifting sensation is deactivated, the motor vehicle behaves like a conventional electric vehicle, and no virtual shifts are simulated, and no virtual shifting sensation is provided.

If, on the other hand, the device 13 for generating the virtual shifting sensation is activated, it provides a virtual shifting sensation depending on the activated operating mode by executing virtual shifts, simulating a virtual gearbox, in particular embodiments by the device 13 for generating the virtual shifting sensation controlling the electric motor 11 in such a way that it provides a torque curve at the output 12 as would be formed when a gear change is performed in a multi-speed manual gearbox of a combustion engine vehicle.

The device 13 for generating the virtual shifting sensation simulates not only a virtual gearbox but also a virtual internal combustion engine, based on whose virtual engine speed and/or virtual torque virtual shifts are performed, and in particular embodiments in the first, automatic operating shift mode.

If, in the first, automatic operating mode, based on a driver-side actuation of the accelerator pedal and/or based on a driver-side actuation of the brake pedal, virtual shift points based on the virtual engine speed of the virtual internal combustion engine and/or on the virtual torque of the virtual internal combustion engine are reached, virtual shifts can be performed. This is done, in particular embodiments, in a map-based manner via virtual shift maps of a virtual shift strategy.

The virtual engine speed of the virtual internal combustion engine can be simulated by the device 13 for generating the virtual shifting sensation in that, depending on a driving speed or rotational speed known on the control side at the drive output 12 of the electric vehicle 10 or the rotational speed of the electric motor 11 and the virtual transmission of a virtual gear that has been engaged, the virtual engine speed of the virtual internal combustion engine is calculated.

Depending on the virtual engine speed of the virtual internal combustion engine calculated in this way, the device 13 for generating the virtual shifting sensation can determine a virtual torque of the virtual internal combustion engine in a map-based or characteristic curve-dependent manner, namely based on a virtual engine map of the virtual internal combustion engine.

FIG. 2 shows a driving direction selector 14 as further assemblies of the electric vehicle 10, with which one of the driving directions forward D, reverse R or also neutral N can be selected.

According to an embodiment of the present disclosure, in order enhance the driving experience while maintaining the driving stability when performing of virtual shifts via the device 13, for generating a virtual shifting sensation, it is proposed that, depending on detected cornering, virtual shifts of the device 13 for generating a virtual shifting sensation, namely, virtual downshifts and/or virtual upshifts, are prevented to ensure the travel stability of the electric vehicle 10, and in particular embodiments during dynamic cornering at high driving speeds.

If the device 13 for generating the virtual shifting sensation can be operated in both an automatic operating mode and a manual operating mode, the device 13 for generating the virtual shifting sensation only prevents virtual upshifts and/or virtual downshifts depending on detected cornering when the automatic operating mode of the device 13 for generating the virtual shifting sensation is active. In manual operating mode, virtual upshifts and virtual downshifts triggered by the driver, and in particular embodiments, during dynamic cornering are also to be approved and not suppressed.

In a preferred embodiment, a curve travel detection device of the electric vehicle 10 or the device 13 for generating the virtual shift sensation of the electric vehicle 10 is configured, in a preferred embodiment, to detect a curve journey depending on a longitudinal acceleration of the electric vehicle 10, wherein the longitudinal acceleration of the electric vehicle 10 is, in a preferred embodiment, measured with a corresponding accelerometer. Alternatively, it is also possible to calculate the longitudinal acceleration of the electric vehicle 10.

Then, cornering is detected depending on the longitudinal acceleration of the motor vehicle 10, it is in particular embodiments, contemplated that cornering that results in the prevention or suppression of virtual shifting is detected when the current, in particular embodiments measured, longitudinal acceleration is greater than a limit value. This limit value is, in particular embodiments, dependent on a current driving speed and/or a current driving mode and/or a current virtual gear of the device 13 for generating the virtual shifting sensation.

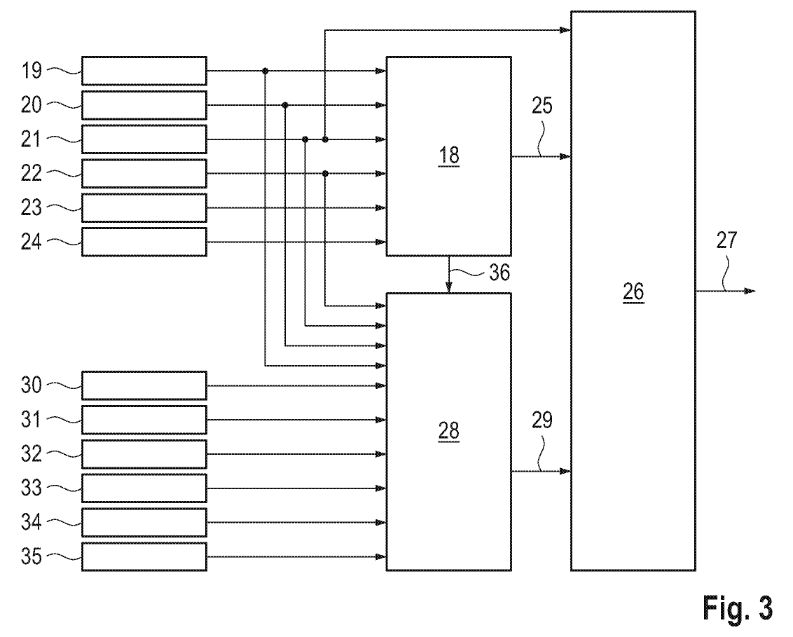

In FIG. 3, block 18 serves to detect cornering depending on input variables 19 to 24, wherein block 18 is, in particular embodiments, a component of the device 13 for generating the virtual switching sensation.

Block 18 is provided with a plurality of input variables, such as the first input variable 19, the measured longitudinal acceleration in particular as the second input variable 20, a selected driving direction, which is specified in particular on the driver’s side using the driving direction selector 14, and as a third input variable 21, a driving travel mode which, in the example embodiment shown, can be specified via a driving mode selection device 37 installed on the steering wheel 15. The driving mode may be an eco-driving mode, a range-driving mode, a sport-driving mode, a performance-driving mode, or also a race-driving mode. The fourth input variable 22 provided to block 18 is the current virtual gear of device 13 for generating the virtual shifting sensation, the fifth input variable 23 is the current driving speed, and the sixth input variable 24 is a sport’s factor, which can also be specified by the driver. The aforementioned input variables 19 to 24 for the block 18 need not all be in common and used to detect cornering. It is possible that in particular the sixth input variable 24, i.e. the sportiness factor, is not used when detecting cornering.

Block 18 checks whether the vehicle is cornering, in particular embodiments by comparing the, in particular measured, current longitudinal acceleration provided as the input variable 19, with a limit value. This limit value can be determined in block 18 depending on one or more of the input variables 20 to 24, in particular embodiments depending on the map, depending on the current driving mode provided as the third input variable 21 and/or depending on the current virtual gear provided as the fourth input variable 22 and/or depending on the current driving speed provided as the fifth input variable 23 and/or depending on the sportiness factor provided as the sixth input variable 24. Accordingly, in block 18, the limit value with which the, in particular embodiments measured, current longitudinal acceleration for cornering detection can be compared depending on the current driving speed according to the fifth input variable 23 and/or depending on the current driving mode according to the third input variable 21 and/or depending on the current virtual gear according to the fourth input variable 22.

Then, if the, in particular embodiments measured, current longitudinal acceleration according to the first input variable 19 is greater than the determined limit value, cornering can be detected in block 18. Then, when cornering is detected, block 18 outputs an output variable 25 based on which suppression of virtual shifts by device 13 for generating the virtual shift sensation may occur.

Then, if the current longitudinal acceleration of the electric vehicle 10 is greater than the limit value, virtual shifting can be suppressed by outputting an output variable 25, wherein it is particularly provided that virtual downshifts and/or virtual upshifts of the device 13 for generating the virtual shifting sensation during detected cornering are only prevented if the forward driving stage D is active as the driving stage. Therefore, the second input variable 20 is also provided to block 18 via the driving stage or the driving direction.

If the forward driving stage or forward driving direction D is active and the current longitudinal acceleration of the electric vehicle 10 is greater than the respective limit value, block 18 outputs the output variable 25 via the entry into the suppression of virtual upshifts and/or virtual downshifts. This output variable 25 of block 18 serves as the input variable for block 26, wherein block 26 is also part of the device 13 for generating the virtual shifting sensation. The block 26 ultimately outputs an output variable 27, depending on which the device 13 for generating the virtual shifting sensation performs or suppresses virtual upshifts and/or virtual downshifts. The output variable 27 of the block 26 corresponds to such a switching vector. If block 18 specifies that virtual shifting suppression is to be initiated, then the switching vector determined by block 26 is set such that virtual upshifts and/or virtual downshifts are suppressed by the device 13 and thus not performed.

While block 18 of FIG. 3 outputs output variable 25 as an output variable via a desired entry into the suppression of virtual downshifts and/or virtual upshifts, a block 28 of FIG. 3 outputs an output variable 29 via a desired exit from the shift suppression, and in turn provides this output variable 29 to the block 26, which, depending on the output variables 25, 29 of blocks 18, 28, determines the output variable 27 in order to either suppress virtual upshifts and/or virtual downshifts or allow them. If the output variable 25 of the block 18 specifies an entry into the shift suppression, but the output variable 29 does not specify an exit, virtual upshifts and/or virtual downshifts are prevented based on the output variable 27. If, on the other hand, the output variable 29 of the block 28 specifies an exit from the shift suppression, the output variable 27 is determined by the block 26 such that subsequent virtual downshifts and/or virtual upshifts are in turn permitted by the device 13 for generating the virtual shifting sensation.

In addition to the input variables 19, 20, 21, and 22 that are also fed as input variables to block 18, further input variables 30, 31, 32, 33, 34, 35 and 36 are also fed to block 28, on the basis of which block 28 then determines whether to exit the suppression of virtual downshifts and/or virtual upshifts, i.e. whether to end the suppression of virtual downshifts and/or virtual upshifts.

In particular embodiments, the suppression of virtual downshifts and/or virtual upshifts can be ended when forward driving stage D is no longer active, for example when the driver has shifted from forward driving stage D to neutral N. Corresponding information about this is provided to block 28 from input variable 20.

Then, when the device 13 prevents virtual downshifts based on detected cornering in order to generate the virtual shifting sensation, the device 13 may be configured to end the prevention of virtual downshifts when a virtual engine speed in the current virtual gear falls below a virtual idling speed. To this end, the virtual engine speed is then provided as a further input variable 30 to block 28 alongside the current virtual gear of the input variable 22.

Then, when the device 13 for generating the virtual shifting sensation prevents virtual upshifts based on detected cornering, the device 13 for generating the virtual shifting sensation may be configured to end the prevention of virtual upshifts when the virtual engine speed in the current virtual gear exceeds a virtual speed limit value. Again, this verification is performed based on the input variable 22 via the current virtual gear and based on the input variable 30 via the virtual engine speed.

Furthermore, the device 13 for generating a virtual shifting sensation can be configured such that when it prevents virtual downshifts and/or virtual upshifts based on detected cornering, the prevention of virtual downshifts and/or virtual upshifts is stopped when a timer has elapsed. Such a timer is in particular started when a driver-side actuation of the accelerator pedal is greater than a limit value. For example, a driver-side actuation of the accelerator pedal is provided to block 28 as a further input variable 31 in order to start the timer when the driver-side actuation of the accelerator pedal is greater than the respective limit value.

In a preferred embodiment, such a timer is started when the current lateral acceleration becomes less than the limit value for recognizing a cornering maneuver. The limit value can be equipped with a hysteresis. Such a timer, which is started when the current longitudinal acceleration is less than the limit value for cornering recognition, if necessary in conjunction with an applicable hysteresis, serves in particular to prevent unwanted ending of cornering recognition by briefly falling below the limit value and thus preventing unwanted virtual shifts. Accordingly, if the current longitudinal acceleration falls below the limit value for the recognition of a cornering maneuver preferably applied with a hysteresis, the prevention of virtual downshifts and/or virtual upshifts is not stopped until the timer has expired. For this purpose, the transverse acceleration limit value determined in block 18 is provided to block 28 by block 18 as the input variable 36, and the input variable 19 regarding the current transverse acceleration is further provided to block 28 in order to then start the time, when the electric vehicle lateral acceleration is or becomes less than the limit value, after the expiry of which the suppression of virtual downshifts and/or virtual upshifts is then stopped.

It is also possible to start the timer when a cruise control or a distance control speed is activated on the driver side and when furthermore the lateral acceleration of the electric vehicle 10 is or becomes less than the limit value determined in block 18. When the cruise control or distance control is or becomes activated on the driver side and the lateral acceleration of the electric vehicle is or becomes less than the limit value, then the timer is started, after the expiry of which the suppression of virtual downshifts and/or virtual upshifts is stopped.

The status of an activation or deactivation of the cruise control or distance control is provided to the block 28 as the input variable 32. When the timer is activated, after the expiry of which the prevention of virtual downshifts and/or virtual upshifts is exited, it can be provided to end the prevention of virtual downshifts and/or virtual upshifts even when the timer is not yet expired, namely when the virtual engine speed according to input variable 30 changes by more than one limit value based on a current travel mode of the input variable 21.

The input variable 33 is an input variable based on driver-side actuation of the sequential shifting elements 16, 17. If the driver actuates at least one of the shift paddles 16, 17, then, also in block 28, virtual downshifts and/or virtual upshifts can be exited from the prevention in order to allow virtual downshifts and/or virtual upshifts even during a cornering maneuver.

The stopping of the prevention or suppression of virtual downshifts and/or virtual upshifts in block 28 can be associated with a delay time, in order to then, when it is recognized in block 28 based on operating conditions of the electric vehicle 10 that in case of a cornering maneuver the prevention or suppression of virtual shifts is to be exited, virtual downshifts and/or virtual upshifts are subsequently provided with a defined delay time, wherein the input variables 34, 35 provide corresponding delay times in terms of an upshift delay and a downshift delay.

According to FIG. 3, not only the input variable 25 and the input variable 29 are provided in block 26, based on which the shifting vector 27 is determined in block 26, but also the input variable 21 regarding the travel mode. Based on the travel mode, torque-based and/or speed-based virtual shift points can be adapted in the shifting vector 27 in order to adapt the shift to a desired travel mode.

When a cornering maneuver is recognized in block 18, not only can a virtual downshift and/or virtual upshift be prevented, but rather, it is also possible to adapt the torque provided by the electric motor 11 at the output 12 to the provision of a uniform force distribution and maximum traction during the cornering maneuver, based on a recognized cornering maneuver.

For example, in an electric vehicle 10 with two driven axles, it is possible to adapt the torque distribution between the two driven axles based on a recognized cornering maneuver. Furthermore, it is possible to limit torque changes when a cornering maneuver is recognized, so that upon cornering, the torque provided by the electric motor 11 at the output 12 may not change by more than a limit value. Furthermore, in a four-wheel driven electric vehicle 10, a load distribution between inside-curve wheels and outside-curve wheels can be adapted, again with the goal of maximum traction and optimal driving stability.

It is provided that the device 13 for generating the virtual shifting sensation is configured so as to provide feedback to the driver about whether a cornering maneuver has been recognized and/or whether virtual shifts are being prevented or suppressed. This can be in the form of an acoustic feedback or also optical feedback, for example in an instrument cluster or in a central display.

Embodiments of the present disclosure also relate to the method for operating an electric vehicle 10 and the electric vehicle 10, which has the drive unit comprising at least one electric motor 11 and the device 13 for generating a virtual shifting sensation. The device 13 for generating the virtual shifting sensation is configured so as to prevent virtual downshifts and/or virtual upshifts based on a cornering maneuver.

The device 13 for generating the virtual shifting sensation is configured so as to recognize a cornering maneuver based on a lateral acceleration of the electric vehicle 10, wherein, when the current lateral acceleration is greater than a limit value based on a current driving speed and/or a current travel mode and/or a current virtual gear of the device 13 for generating a virtual shifting sensation, a cornering maneuver of the electric vehicle is recognized.

The device 13 for generating the virtual shifting sensation is, in a preferred embodiment, configured so as to prevent the virtual downshifts and/or virtual upshifts upon a recognized cornering maneuver, preferably only when the forward drive stage D is active as the drive stage. Furthermore, the device 13 for generating a virtual shifting sensation is, in a preferred embodiment, configured such that when it prevents virtual downshifts and/or virtual upshifts based on a recognized cornering maneuver, the prevention of the virtual downshifts and/or virtual upshifts is stopped when the forward drive stage D is no longer active as the drive stage. The device 13 for generating the virtual shifting sensation is, in a preferred embodiment, further configured such that, when it prevents virtual downshifts based on a recognized cornering maneuver, the prevention of the virtual downshifts is then stopped when a virtual engine speed in the current virtual gear falls below a virtual idling speed. The device 13 for generating the virtual shifting sensation is, in a preferred embodiment, further configured such that, when it prevents virtual upshifts based on a recognized cornering maneuver, the prevention of the virtual upshifts is then stopped when a virtual engine speed in the current virtual gear exceeds a virtual speed limit value. In particular embodiments, the device 13 for generating the virtual shifting sensation is configured so as to only prevent virtual downshifts and/or virtual upshifts when the automatic operating mode of the device 13 for generating the virtual shifting sensation is active.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating an electric vehicle, the electric vehicle comprising a drive unit comprising at least one electric motor, and a device for generating a virtual shifting sensation, the method comprising:
preventing, depending on a detected cornering of the electric vehicle, virtual downshifts and/or virtual upshifts of the device for generating the virtual shift sensation.

2. The method according to claim 1, wherein preventing the virtual downshifts and/or the virtual upshifts further comprises:
when the cornering is detected, the virtual downshifts and/or the virtual upshifts of the device for generating the virtual shifting sensation are only prevented when a forward driving stage is active as a driving stage.

3. The method according to claim 2, wherein when the virtual downshifts and/or the virtual upshifts of the device for generating a virtual shifting sensation are prevented based on the detected cornering, the prevention of virtual downshifts and/or virtual upshifts are ended when a forward driving stage is no longer active as a driving stage.

4. The method according to claim 1, wherein, if the virtual downshifts of the device for generating the virtual shifting sensation are prevented based on the detected cornering, the prevention of virtual downshifts is then ended when a virtual engine speed in a current virtual gear is below a virtual idling speed.

5. The method according to claim 1, wherein, when the virtual upshifts of the device for generating the virtual shifting sensation are prevented based on the detected cornering, the prevention of the virtual upshifts is then ended when a virtual engine speed in a current virtual gear exceeds a virtual speed limit value.

6. The method according to claim 1, wherein, when the virtual downshifts and/or the virtual upshifts of the device for generating the virtual shifting sensation are prevented based on the detected cornering, the prevention of the virtual downshifts and/or the virtual upshifts is ended when a timer has elapsed.

7. The method according to claim 6, wherein the timer is then started when a longitudinal acceleration of the electric vehicle is less than a limit value.

8. The method according to claim 6, wherein the timer is then started when a driver-side actuation of an accelerator pedal is greater than a limit value.

9. The method according to claim 6, wherein the timer is started when a cruise control or a distance control is activated on a driver side.

10. The method according to claim 6, wherein if the timer has not elapsed, the prevention of the virtual downshifts and/or the virtual upshifts of the device for generating the virtual shifting sensation is ended when a virtual engine speed changes by more than one limit value dependent on a current driving mode.

11. The method according to claim 1, wherein when an automatic operating mode of the device for generating the virtual shifting sensation is activated, a virtual automatic shifting sensation is generated, and then when a manual operating mode of the device for generating the virtual shifting sensation is activated, a virtual manual shifting sensation is generated.

12. The method according to claim 11, wherein preventing the virtual downshifts and/or the virtual upshifts further comprises:
preventing the virtual downshifts and/or the virtual upshifts only when the automatic operating mode is activated.

13. The method according to claim 1, wherein the cornering is detected depending on a longitudinal acceleration of the electric vehicle when the current longitudinal acceleration of the electric vehicle is or becomes greater than a limit value.

14. The method according to claim 13, wherein the limit value is dependent on a current driving speed and/or a current driving mode and/or a current virtual gear of the device for generating the virtual shifting sensation.

15. An electric vehicle, comprising:
a drive unit comprising at least one electric motor; and
a device configured to generate a virtual shifting sensation, wherein,
the device for generating the virtual shifting sensation is configured to prevent virtual downshifts and/or virtual upshifts depending on a detected cornering.

16. The electric vehicle according to claim 15, wherein the device for generating the virtual shifting sensation is further configured to detect the cornering depending on a longitudinal acceleration of the electric vehicle, wherein if the current longitudinal acceleration is greater than a limit value dependent on a current driving speed and/or a current driving mode and/or a current virtual gear of the device for generating the virtual shifting sensation, the device for generating the virtual shifting sensation detects the cornering of the electric vehicle.
